(19) United States
(12) Patent Application Publication
(10) Pub. No.: US 2011/0318252 A1
(43) Pub. Date: Dec. 29, 2011

(54) Process for producing gas from mineral ore

(75) Inventors: Francis Coustry, Alsemberg (BE); Perrine Davoine, Brussels (BE); Claude Criado, Brussels (BE); Thoi-Dai Chau, Dombasle-sur-meurthe (FR)

(73) Assignee: SOLVAY SA, Brussels (BE)

(21) Appl. No.: 13/147,722

(22) PCT Filed: Feb. 9, 2010
(86) PCT No.: PCT/EP10/51601

§ 371 Date: Sep. 12, 2011

(30) Foreign Application Priority Data
Feb. 9, 2009 (EP) 09152392.8

(51) Int. Cl. C01D 7/00; C01B 31/20

(52) U.S. Cl. 423/421; 252/372

(57) ABSTRACT

Process for producing a gas from a mineral ore, and in particular from trona ore, said gas having a carbon dioxide concentration of more than 25 volume percents expressed on dry gas, and a quantity of volatile organic compounds of less than 700 mg per kilogram of generated carbon dioxide. The process comprises the steps of crushing the trona ore, introducing crushed trona in a rotary calcining drum with indirect heating, calcining the crushed trona in the calcining device, collecting the calcined trona from calcining device and collecting the gas generated by the trona ore calcination from calcining device in order to constitute the produced gas.

### CROSS-REFERENCE TO RELATED APPLICATIONS

The present application claims benefit of the European patent application No. 09152392.8 filed Feb. 9, 2009.

### FIELD OF THE INVENTION

This invention relates to a process for producing gas from mineral ore, particularly from trona ore. It also relates to the produced gas, and uses of this gas.

### BACKGROUND OF THE INVENTION

Trona ore is a mineral that contains about 80-95% sodium sesquicarbonate (Na₂CO₃.NaHCO₃.2H₂O). A vast deposit of mineral trona is found in southwestern Wyoming near Green River. This deposit includes beds of trona and mixed trona and halite (rock salt or NaCl) which covers approximately 2,600 km². The major trona beds range in size from less than 428 km² to at least 1,870 km². By conservative estimates, these major trona beds contain about 75 billion metric tons of ore. The different beds overlap each other and are separated by layers of shale, and oil shales. The quality of the trona varies depending on its particular location in the stratum.

A typical analysis of the trona ore mined in Green River is as follows:

TABLE 1

| Constituent | Weight Percent |
|---|---|
| Na₂CO₃ | 43.6 |
| NaHCO₃ | 34.5 |
| H₂O (crystalline and free moisture) | 15.4 |
| NaCl | 0.01 |
| Na₂SO₄ | 0.01 |
| Fe₂O₃ | 0.14 |
| Insolubles | 6.3 |
| Organics | 0.3 |

The sodium sesquicarbonate found in trona ore is a complex salt that is soluble in water. The trona ore is processed to remove the insoluble material, the organic matter and other impurities to recover the valuable alkali contained in the trona.

The most valuable alkali produced from trona is sodium carbonate. Sodium carbonate is one of the largest volume alkali commodities made in the United States. In 2007, trona-based sodium carbonate from Wyoming comprised about 90% of the total U.S. soda ash production. Sodium carbonate finds major use in the glass-making industry and for the production of baking soda, detergents, paper products.

A common method to produce sodium carbonate from trona ore is known as the “monohydrate process”.

In that process, crushed trona ore is calcined (i.e., heated) into crude sodium carbonate which is then dissolved in water. The resulting water solution is purified and fed to a crystallizer where pure sodium carbonate monohydrate crystals are crystallized.

During calcination, the sodium sesquicarbonate molecules present in trona ore breaks down into solid sodium carbonate, and gaseous carbon dioxide and water vapor. Organics present in natural ore, are partially degraded. Part of the organics remain in the calcined ore, part of organics are released in resultant calcined gas or vapors.

A typical design for trona calciners is direct firing rotary calciners (Natural Soda Ash, D. E. Garett, Ed Van Nostrand Reinhold editor, New York, 1992, Chapter 8 Production pp 270-275). The direct firing is operated with air and natural gas or grinded coal: the hot burning gases are injected in the rotary calciner. The hot direct firing gases contain air excess to enable a correct combustion of natural gas or coal, plus the non reacted nitrogen (N₂) from combustion air, plus some common gaseous pollutants formed by the flame combustion such as nitrogen oxides, and sulfur oxides. During trona calcination, generated water vapor, carbon dioxide gas, and volatile organic compounds are diluted with the hot direct firing gases. The resulting gas present in the calciner, and emitted by the calciner, contains firing gases plus the gases generated by trona calcination. For that reason they are diluted in carbon dioxide (from 10 to 15 volume % on dry gas). This diluted gas can be dedusted and washed to remove calcined trona particles and then release into atmosphere.

One other use of sodium carbonate is the production of sodium bicarbonate (baking soda). Sodium bicarbonate is a product with a wide range of interesting properties and a wide range of applications from high purity for the pharmaceutical industry to the human food and animal feed, and to the use of technical grade for chemical industry.

The production of sodium bicarbonate is currently almost entirely made by the carbonation of sodium carbonate.

In the USA, the carbonation is usually made in separate plants which purchase independently the soda ash and the CO₂ and combine them.

The carbon dioxide production is traditionally recovered from other processes and distributed most commonly as liquid carbon dioxide. Large amounts of carbon dioxide are recovered from naturally occurring underground sources. This underground carbon dioxide can be almost 100% pure with a small percentage of a mixed-gas stream. Such carbon dioxide is often used in beverage or pharmaceutical industries.

Liquid carbon dioxide is also recovered as a gaseous by-product of industrial operations such as: hydrogen production for ammonia by steam reforming of natural gas, ethylene oxide production, or ethanol production by fermentation. The gaseous carbon dioxide is compressed and piped in nearby plants or it is liquefied for sale as a merchant product because liquid carbon dioxide can be transported more economically than gaseous.

Since the carbon dioxide generated by existing lines of trona calcination is diluted and polluted by several gaseous pollutants, its use for making other pure chemicals such as food and pharmaceuticals is not relevant.

Some tentatives have been described to improve the calcining step of the monohydrate process by using fluidized bed technology. U.S. Pat. No. 6,479,025 describes an apparatus for the calcination where the calcining chamber contains indirect heating elements, a bed plate located below the heating elements, and a plurality of holes for introducing fluidizing gas. The amount of soluble organics generated in the calcined trona is mentioned to be low.

Such equipments have the disadvantage to need a selective crushing with a narrow particle size range of the mineral ore: coarser particles will fall onto the plate if their weight is too heavy to be fluidized, and so will need a longer time to be removed from the calciner, and the finer particles that are light will be taken away with the fluidized gas and will remove high amount of materials from calcining chamber. Moreover such fluid bed calcining technology needs large quantity of compressed fluidizing gas, typically from 0.5 to 1.0 ton of gas per ton of mineral ore. This dusted gas will have to be settled down or filtrated by expensive equipments. In a low temperature fluidized bed, oil shales particles, that have a higher density that the one of calcined trona, are less fluidized than calcined, or partially calcined, trona particles. Being less fluidized, they remain a longer time in the calciner than calcined ore. This longer residence time is detrimental to volatile organics compounds content of the gas generated by the trona calcination: volatile organics present in oil shales will be freed in a more important quantity in the gas.

As a result of the above disadvantages of known calcination technologies, there remains a need for an improved process for calcining trona and producing economically a good quality gas containing carbon dioxide for further uses.

### BRIEF DESCRIPTION OF THE DRAWING

FIG. 1 is a scheme of one embodiment of the present invention of an introduction device for introducing crushed trona ore in an indirect heating calciner. A rotary drum (1), equipped with heating tubes (2), is fed with crushed trona through the solid introduction inlet (3) into an introduction device formed by a rotating screw (4), delivering the crushed trona at the screw outlet (5) inside the heated section of the rotary drum. A dry gas can optionally be injected through a gas inlet (6) to avoid vapor gas upstream towards crushed trona solid introduction (3). The outer surface of the introduction device around the screw is equipped with a double shield (7) that can be heated with a hot fluid to heat the introduction device.

### DESCRIPTION OF THE INVENTION

The present invention relates to a process for producing a gas from a mineral ore, and in particular from trona ore, said gas having a carbon dioxide concentration of more than 25 volume percents expressed on dry gas, and a reduced quantity of volatile organic compounds expressed in mg of carbon per kilogram of generated carbon dioxide of less than 700 mg/kg, comprising the steps of:
a) crushing the trona ore
b) introducing crushed trona in a calcining device
c) calcining the crushed trona in the calcining device
d) collecting the calcined trona from the calcining device
e) collecting the gas generated by the trona ore calcination from calcining device in order to constitute the produced gas
   wherein said calcining device is a rotary drum with indirect heating.

In a first embodiment of the present invention the step c) is carried out in presence of an ambient gas in the rotary drum, and air entries in the calcining device are limited so that the oxygen concentration in the ambient gas in the rotary drum is less than or equal to 6 volume percents, preferably less than or equal to 4 volume percents.

In a second embodiment of the present invention the step c) of calcining the crushed trona is carried out at temperature below 200° C.

In a third embodiment of the present invention the step c) is carried out in presence of an ambient gas in the rotary drum containing water vapor at a concentration of at least 50 volume percent.

Those different embodiments can be combined one to another or all together.

The increased purity of the gas obtained as such enables its use now in a variety of other applications.

Moreover the process according to the present invention enables a significant decrease on energy consumption of up to 30% compared to the other cited trona ore calcining processes.

In a preferred embodiment the ore is crushed at a size below 1.3 cm (0.5 inch) or more preferably 0.7 cm (0.25 inch). This size reduction can be operated with a roll, a hammer, or an impact mill. The milling device can be associated with a granulometry classifier or a screening step to avoid very coarse particles to be introduced in the rotary indirect calciner.

The ore can be enriched by standard mining techniques selected from magnetic separation, electrostatic separation, flotation, density separation or a combination thereof. This enrichment can be done, during crushing operation or before introducing the crushed ore in the calciner. This ore enrichment or purification may be operated if the sodium sesquicarbonate content is low, or if an impurity has to be removed in order to generate a lower concentration of this impurity in the produced gas or the produced calcined trona.

The crushed ore is then introduced in a rotary indirect heating calciner. Preferably the rotary indirect heating calciner comprises a rotary drum equipped with and indirect heating element.

Such indirect heating rotary drums, frequently used in soda ash industry for the Solvay process, are not used in the natural soda ash industry for ore calcining. Crushed trona ore is coarser than typical refined light soda ash or sodium monohydrate carbonate particles leading to longer residence time for calcination of coarse particles. Ore inlet plugging, and ore plugging between steam tubes, is an important issue as it decreases operation time. Inventions have tried to solve the plugging issue at the product inlet or between heating tubes such as U.S. Pat. No. 2,851,792 or GB799251, in which part of the dried or partially dried particulate solids is recycled to the input of the drum.

In present invention, the ore introduction can be a simple inlet chute. In a preferred embodiment of the invention, the crushed trona feeding is operated with a device that limits air introduction in the calciner.

The indirect heating rotary drum of present invention is generally operated under partial vacuum in order to avoid dust emission in the environment of the rotary drum, through solid or gas inlets or outlets of the calcining device, and also through the flanges between static parts and rotating parts of the rotary drum. The partial vacuum in the rotary drum is generally carried out by placing a fan downstream in the collected generated gas circuits. The partial vacuum relatively to ambient pressure is generally less than 1000, preferably less than 500, and most preferably less than 100 Pascal. The more the partial vacuum is, the more air enters in the calcining device.

In present invention the amount of air introduced in the calcining device is such that produced calcined trona gas has a carbon dioxide concentration of more than 25 volume % expressed on dry gas. The amount of air introduced in the calcining device can be further limited, as to obtain a carbon dioxide concentration expressed on dry gas of: more than 40 volume %, preferably more than 60 volume % and most preferably more than 80 volume %.

We have found surprisingly that when limiting maximum calcining temperature, using an indirect heating rotary drum calcining device, and concomitantly limiting air introduction in the calcining device, the amount of volatile organic compounds is reduced compared to known technologies. This enables the recovery of the generated CO₂ and its subsequent use, for instance, for producing sodium bicarbonate of good purity such as pharmaceutical and food grades.

In a variant embodiment of the invention the amount of air introduced in the calcining device is limited so that produced calcined trona gas has a water vapor concentration of more than 50 volume %, preferably more than 60 volume % and most preferably more than 70 volume % in humid gas.

The crushed trona feeding device that limits air introduction in the calciner can be a rotary valve or a screw, or the association of those two equipments.

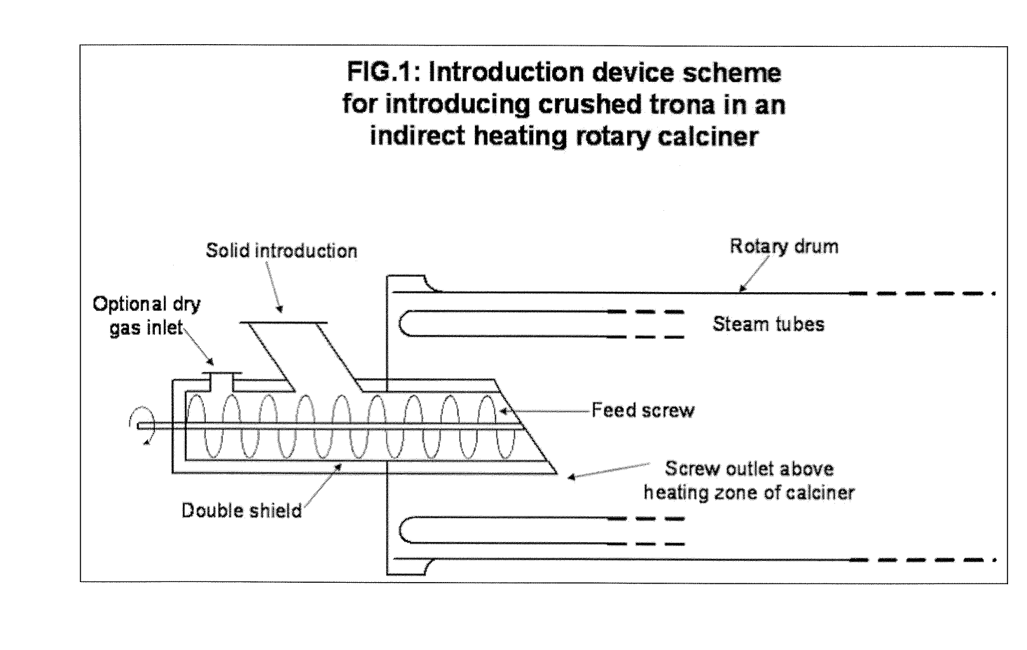

In a preferred embodiment, the crushed trona feeding device is a screw and the crushed trona outlet of the screw is localized in the heated section of the rotary calcining device. In that manner the cool crushed trona falls on an already heated product. This can be performed if the crushed trona falls on a section of the rotary drum where indirect heating elements are present with already heated crushed trona. FIG. 1 illustrates one of such configuration.

The introduction device can advantageously be equipped with a local heating system enabling to raise the temperature of the equipment exterior wall in contact with the calciner gas atmosphere. Particularly, the temperature of the equipment exterior wall is heated above the dew point temperature of the calciner atmosphere. This avoids that the introduction device be covered with condensates that will provoke crusts and avoid the plugging of the crushed trona outlet. Advantageously the temperature of the equipment exterior wall is above about 70° C., and preferably above about 80° C. The temperature of the equipment exterior wall is generally less than about 100° C., preferably less than about 95° C.

In one embodiment of the invention, the crushed trona can be pre-heated before its introduction in the calcining device. The pre-heating raises also the temperature of the crushed trona above the dew point temperature of the calciner atmosphere. In this case, the temperature of the heated trona is above about 70° C., or preferably above about 80° C. The temperature of the heated trona is generally less than about 100° C., preferably less than about 95° C.

The pre-heating of the crushed trona can be realized with a recycling loop of already hot calcined trona; it can be done also with a pre-heating equipment using infra-red, microwave, or hot gas injection inside the crushed trona chute or inside the crushed trona introduction device, for example in the dry gas inlet mentioned in FIG. 1.

The indirect heat of the calciner device can be brought by the outer wall of the drum if it is heated externally. The indirect heat of the calciner device can also be brought with internal heating elements such as steel tubes heated with a hot fluid. The hot fluid can be a hot liquid as oil, or a hot gas as water steam.

In a preferred embodiment, the indirect heating is carried out with a hot fluid at a temperature less than or equal to 260° C., more preferably less than or equal to 250° C., and most preferably less than 240° C. The indirect heating is carried out preferably with a hot fluid at a temperature at least equal to 150° C., more preferably at least equal to 180° C., and most preferably at least equal to 210° C.

In that preferred embodiment the heating elements can be steel tubes heated with pressurized water steam. The steel tubes can be smooth tubes or be externally shaped with an outer wall that increases the outer surface such as finned tubes, grooved tubes or otherwise machined tubes. When finned tubes are used, welded helical stripes are sufficiently thick to bring mechanical resistance, and a pitch distance of the helical stripe is chosen at least three times the coarser trona particles size, to avoid plugging of the product in the stripes.

The tubes can be arranged in tubes bundles. The minimal distance between the inner wall of the drum and the outer wall of the tubes will be three times the coarser trona particles size to avoid coarse particles plugging. Also the minimal distance between the outer wall or most external point of the tubes surfaces of two adjacent tubes will be three times the coarser trona particles size to avoid coarse particles being plugged between two tubes.

When heating is provided by steam tubes placed in the rotary drum, the steam tubes defining a steam tubes section of the rotary drum, the crushed trona ore is advantageously introduced inside the steam tubes section of the rotary drum. This enables to rapidly heat the ore and avoid sticky solid clogging at the entrance of the drum. Indeed it has been observed in the present invention, that when crushed trona is at temperature between 15 to 40° C. and is introduced directly into the rotary drum before the steam tube section, the crushed trona particles form sticky particles clogging like a paste that plugs in few hours the corresponding section of the rotary drum. As, when the crushed trona ore is introduced inside the steam tubes section of the rotary drum, for instance with such an introducing screw represented at FIG. 1, this problem is solved and the rotary drum can operates more than 500 hours without any observed problem.

In an other advantageous mode of that preferred embodiment of the invention the steam tubes are heated by steam produced with an electricity and steam cogeneration power plant.

The rotary drum can have its axis slightly inclined to the horizontal, for example with a slope of the order of 0.10 to 4.0%. The drum is subjected to slow rotation, that homogenizes the particles distribution in the drum and renewed particles contact with the heating elements. The trona ore particles reach thereof a temperature slightly higher than the temperature of transition of sesquicarbonate to sodium carbonate, for example a temperature from 2° to 40° C. higher. The rotary movement allows calcined trona particles to progressively reach the extremity of the drum where they are removed.

Internal surface of the rotary drum can be equipped with lifting flights in part of the sections of the drum to improve particle mixing and movement of solid particles downstream.

If minimum sodium sesquicarbonate content is desired in the calcined product, suitable heating elements surface and heating fluid temperature have to be adjusted in order to reach a minimum final temperature of the calcined trona. For example to have less than 1 weight % of non calcined sodium sesquicarbonate, a suitable end temperature of the solid has to be adjusted between 130° C. and 180° C., more advantageously between 150 and 170° C.

To ensure the necessary residence time of the particles within the drum, the downstream extremity of the rotary drum can be equipped at its outlet with a diaphragm disk concentric to the drum axis, that ensure a level of the particles inside the rotary drum.

The generated gas of trona particles is removed from the calciner via known technique, for example by pumping under slight vacuum the gas. The drum gas outlet is generally equipped with a decantation chamber or a dedusting cyclones device to enable most of particles to be recovered in the calcined trona outlet. The pipes and equipments in contact with the humid trona calcination gas are maintained at a temperature above the dew point temperature in order to avoid water vapor to condensate on the pipes or equipment walls. This can be achieved with pipes and equipment insulation. Or if those equipments are exposed to cooler temperatures they can be equipped with known heating tracing devices between external walls of tubes and the insulation.

The particularly low content in volatile organic compounds associated with a low concentration of oxygen in the generated gas renders more secure the use of electrical devices in purifying, transporting and using the gas.

With the association of the above mentioned steps of the process and the above characteristics of the calcining device, it has been found than the calcined trona gas has a composition of particularly higher quality that the one produced with already existing equipments.

Although not desiring to be bound by a theoretical explanation, the inventors believe that the association of low oxygen content of the calcining atmosphere, the mild temperature of the calcination, the relatively low temperature of heating elements, and a controlled residence time of oil shales in the calcining drum enable to reach a low volatile organic compounds concentration.

Preferably the amount of air introduced in the calcining device as described in present process is such that produced calcined trona gas has a carbon dioxide concentration of more than 25 volume % expressed on dry gas and a volatile organic compound amount of less than 650 mg per kilogram of generated carbon dioxide from trona ore. The air amount in the calcining device can be further reduced such that produced calcined trona gas has a carbon dioxide concentration of more than 40 volume % expressed on dry gas and a volatile organic compound amount of less than 550 mg per kilogram of generated carbon dioxide. Preferably the air amount in the calcining device is reduced such that produced calcined trona gas has a carbon dioxide concentration of more than 60 volume % expressed on dry gas and a volatile organic compound amount of less than 450 mg per kilogram of generated carbon dioxide. And most preferably the air amount in the calcining device is reduced such that produced calcined trona gas has a carbon dioxide concentration of more than 80 volume % expressed on dry gas, and a volatile organic compound amount of less than 350 mg per kilogram of trona ore.

In a most preferred embodiment of the present invention, a gas having a carbon dioxide concentration of more than 80 volume percents expressed on dry gas, and a quantity of volatile organic compounds expressed in mg of carbon per kilogram of generated carbon dioxide of less than 350 mg/kg is produced, comprising the steps of:
a) crushing the trona ore containing more than about 90% sodium sesquicarbonate at a size below 0.7 cm (0.25 inch).
b) introducing crushed trona in a rotary drum equipped with indirect heating tubes fed with pressurized water steam between 20 and 33 bars,
c) calcining the crushed trona in the calcining device, setting the feeding rate of the rotary calciner so that the calcined trona withdrawn from the calciner has final temperature between 150° C. and 170° C., and setting a partial vacuum into the rotary drum so that oxygen concentration in the humid gas present in the rotary drum during calcining is less than 4 volume %,
d) collecting the calcined trona from the calcining device,
e) collecting the gas generated by the trona ore calcination from rotary drum in order to constitute the produced gas.

In a variant embodiment the gas collected at step e) is further treated by:
f) removing part of solid particles
g) removing part of the water vapor of the gas collected at step e) or f).

The removing part of solid particles can be carried out for example with electrostatic precipitators or with bag filters. The surface temperatures of those equipments are maintained at a value higher than the dew point temperature of the gas. The calcined gas can be then cooled with known techniques such as gas scrubbers or plate type vapor condensers in order to remove part of the water containing gas and being able to compress and transport the gas.

In an other variant embodiment the gas extracted from step g) is further treated in one or several steps selected from drying, concentration, purification, odor removal, carbon dioxide liquefaction and combinations thereof.

Examples of known techniques of drying the gas are: cooling it a low temperature, or passing it through an activated alumina, bauxite, or silica gel drier that are regenerated by heating, or scrubbing it into concentrated sulfuric acid such as Reich process. Example of known techniques of concentrating the gas is amine concentration techniques as Girbotol recovery unit. Example of odor removal purification is active carbon filtrations such as Backus process, or gas scrubbing into potassium chromate or permanganate to remove trace of organics and hydrogen sulfide.

The purified carbon dioxide can be then further cooled and compressed to obtain liquid or solidified carbon dioxide if wanted.

In an advantageous mode of those two last variant embodiments of the present invention, the obtained gas is used for sodium bicarbonate production.

Consequently present invention relates also to the use of the produced gas for sodium bicarbonate production.

The present invention relates also to the gas obtainable by the process of the present invention.

The following examples are presented to further illustrate the process of the invention.

### Example 1

### Indirect Heating Rotary Calciner Heated with Oil

Influence of the Oxidizing Atmosphere on Volatile Organic Compounds.

A laboratory borosilicate glass flask of 0.5 liter volume was mounted on a rotary axe. It was introduced in a hot oil bath heated at 200° C., in order to cover half of the surface of the glass flask.

A rotary engine was used in order to obtain a rolling mass of solid inside the glass flask when crushed trona was introduced.

A gas vector was injected in the glass flask and then pumped out in order to analyze on stream the amount of volatile organic compounds generated. A heat traced line at 180° C. was used up to a calibrated Flame Ionization Analyzer, used to measure on-stream the amount of volatile organic compounds (VOC), with a continuous monitoring. Measurement protocol was done according EN13526 standard. The VOC amounts were integrated during the whole calcination of the product to give the total VOC generated during calcining. They were expressed as carbon amount and reported to the initial trona amount introduced in the flask.

400 grams sample of crushed trona under 0.3 mm size cut was divided into samples of 200 grams each. 200 grams of divided crushed trona were used for each trial. The samples were chemically analyzed after calcination to check the calcination.

Trial 1.a: the vector gas injected at a rate of 250 liters per hour was nitrogen (N₂): non oxidizing gas, corresponding to an oxygen concentration of less than 1% vol.

Trial 1.b: the vector gas injected at a rate of 250 liters per hour was air corresponding to an oxygen concentration of 14+/−4% on humid gas during calcination.

TABLE 2

| | | | | Total VOC |
|---|---|---|---|---|
| | | Calcination time | Total VOC | mg C/kg |
| Trial | Vector gas | minutes | mg C/kg trona | generated CO₂ |
| 1.a | N₂ | 54 | 19 | 210 |
| 1.b | Air | 33 | 25 | 276 |

The trial 1.b (with air) has been repeated with a longer residence time in the rotary glass flask of 70 minutes rather than 33 minutes. The total VOC amount generated during trial operation was 24 mg C/kg trona, close to the VOC value of 25 mg C/kg trona previously obtained.

### Example 2

### Indirect Heating Rotary Calciner

In this example, a rotary calcining device was used. Its main characteristics were: 0.4 meter diameter, 3.2 meters long, made from stainless steel, equipped internally with twelve 2.8 meters long smooth steam tubes and 48 mm diameter each; steam tubes were fed with pressurized steam at 20, 33 or 40 bars, to heat the calciner. The calciner was continuously fed with crushed trona inferior to 0.7 mm (¼ inch), in order to establish a permanent regime and run continuously on week basis. The crushed trona flow rate feeding the rotary calciner was monitored. The crushed trona feed rate was regulated for each operating conditions in order to have less than 1 weight % of non calcined sesquicarbonate at the calciner outlet. Air entries were limited in order to obtain a carbon dioxide concentration of more than 25 volume % on dry gas, and an oxygen concentration less than 5.9 volume % on humid gas. The corresponding water vapor concentration in the generated gas was 61+/−3 volume %. The gas generated in the rotary calciner was pumped out, and monitored continuously by a calibrated mass flow meter, with also gas pressure and gas temperature monitoring. An isokinetic sampling heated train (above 150° C.) was used to sample continuously the gas generated by trona calcination. The VOC (=total hydrocarbon compounds) concentration of the sampled gas was monitored continuously during one hour on a calibrated Flame Ionization Analyzer according EN13526 standard. The mean value total hydrocarbon during one hour was taken as the amount of generated of VOC, multiplied by the total gas flowrate generated by the rotary calciner. This amount was reported to mass flow of incoming crushed trona during the same time, and to the equivalent generated carbon dioxide.

Table 3 gives the VOC released by trona calcining on several operating conditions for each run trials.

TABLE 3

| | | | Total VOC | |
|---|---|---|---|---|
| | | | released | Total VOC |
| | | | reported to | released |
| | Steam | | calciner feed | reported to |
| Trial | Pressure | Rotary speed | mg C/kg | generated CO₂ |
| Reference | Bar | Rpm | trona | mg C/kg CO₂ |
| 2.a | 21 | 6 | 3 | 33 |
| 2.b | 33 | 6 | 28 | 310 |
| 2.c | 33 | 11 | 21 | 230 |
| 2.d | 40 | 6 | 18 | 200 |

In tested conditions, the total VOC released reported to trona was in between 3 and 28 mg C/kg trona, corresponding to 33 to 310 mg C/kg CO₂.

After three months operation, the heating tubes were clean and no crust was observed on their surface.

### Example 3

### Counter Example

Industrial Direct Firing Rotary Calciners.

In this example direct firing rotary calciners as described in Natural Soda Ash, D. E. Garett, Ed Van Nostrand Reinhold editor, New York, 1992, Chapter 8 Production pp 272-273, were used and operated by coal firing or natural gas firing with external fire boxes. The calciners were operated in co-current: hot gases are introduced at the same extremity as trona crushed ore introduction. Operating conditions were chosen to obtain less than 1% residual sodium sesquicarbonate in the calcined trona.

A sampling train was used in the calciners stack test locations as defined in Wyoming state Permit N^{o} CT-1347. Environment Protection Agency Method 25A was used to determine total hydrocarbons (VOC) concentration measured by a calibrated Flame Ionization Analyzer. To convert the VOC concentration to mass flow rate, the volumetric gas flow rates were determined at the source. The following methods, as described in 40 CFR part 60, Appendix A and 40 CFR Part 51, Appendix M were used (Methods 1, 2, 3, 4, 25A) for sample and velocity traverse for stationary sources, determination of stack gas velocity, and volumetric flow rate type S Pitot tube, gas analysis for the determination of molecular weight, determination of moisture content in stack gases, determination of total gaseous organic concentration using a flame ionization analyzer. Three 60 minutes test runs were performed and the mean value was taken to calculate emitted VOC reported to calciner feed flow rate. Standard deviation of three measures was below +/−17% of the average measure.

### Example 3.a

Coal direct firing calciner, 14.5 feet diameter, 110 feet long, fed at 120 t crushed trona inferior to 0.7 mm (¼ inch) per hour. VOC generated in gas: 210 mg C/kg trona, corresponding to 2320 mg C/kg of generated CO₂ from trona ore.

### Example 3.b

Natural Gas firing calciner, 18.5 feet diameter, 120 feet long, fed at 230 t crushed trona inferior to 0.7 mm (¼ inch) per hour.

Carbon dioxide concentration was 12.4 volume % on dry gas, oxygen concentration was 7 volume % on humid gas, and water vapor was 32 volume %. VOC generated in gas is 85 mg C/kg trona, corresponding to 940 mg C/kg generated CO₂.

Values of generated organic of Examples 1 and 2 (33 to 310 mg C/kg generated CO₂) according present described invention, compared to values in existing direct firing calciners of Example 3 (940 to 2320 mg C/kg trona) show the efficiency of reducing the volatile organic compounds in using present invention.

1. A process for producing a gas from a mineral ore, and in particular from trona ore, said produced gas having a carbon dioxide concentration of more than 25 volume percents expressed on dry gas, and a quantity of volatile organic compounds of less than 700 mg per kilogram of generated carbon dioxide, said process comprising the steps of:
a) crushing the trona ore;
b) introducing crushed trona in a calcining device;
c) calcining the crushed trona in the calcining device;
d) collecting the calcined trona from the calcining device; and
e) collecting the gas generated by the trona ore calcination from the calcining device in order to constitute the produced gas;
wherein said calcining device comprises a rotary drum with indirect heating.

2. The process according to claim 22 wherein the amount of air introduced in the calcining device is further limited so that the produced gas has a carbon dioxide concentration of more than 40 volume percents expressed on dry gas, and a quantity of volatile organic compounds of less than 550 mg per kilogram of generated carbon dioxide.

3. The process according to claim 1 wherein step c) is carried out in presence of an ambient gas in the rotary drum, and wherein air entries in the calcining device are limited so that the oxygen concentration in the ambient gas in the rotary drum is less than or equal to 6 volume percents.

4. The process according to any of claim 1 wherein step c) of calcining the crushed trona is carried out at temperature below 200° C.

5. The process according to claim 1 wherein step c) is carried out in presence of an ambient gas in the rotary drum containing water vapor at a concentration of at least 50 volume percent.

6. The process according to claim 1 wherein the indirect heating is carried out with a fluid at a temperature at least equal to 150° C. and less than or equal to 260° C.

7. The process according to claim 1 wherein the crushed trona ore is pre-heated at a temperature above about 70° C. before being introduced in the calcining device.

8. The process according to claim 1 wherein the crushed trona is introduced in the rotary drum with an introduction device, the outer surface of which is heated above about 70° C.

9. The process according to claim 1 wherein said indirect heating is provided by steam tubes placed in the rotary drum, the steam tubes defining a steam tubes section of the rotary drum, and wherein the crushed trona ore is introduced inside the steam tubes section of the rotary drum.

10. The process according to claim 20, additionally comprising the steps of:
f) removing part of solid particles of the gas collected from step e);
g) removing part of the water vapor of the gas collected from step e) or f); and
h) optionally further processing the gas extracted from step g) with one or several steps selected from the group consisting of purification, concentration, carbon dioxide liquefaction, and combinations thereof.

11. The process according to claim 1, wherein the collected gas is used for sodium bicarbonate production.

12. The process according to claim 1, wherein the calcined trona of step d) is further processed into sodium carbonate.

13. The process according to claim 9, wherein said steam tubes are heated by steam produced with an electricity and steam cogeneration power plant.

14. A gas having a carbon dioxide concentration of more than 25 volume percents expressed on dry gas and having a quantity of volatile organic compounds of more than 33 and less than 700 mg per kilogram of generated carbon dioxide, said gas being obtainable by the process according to claim 1.

15. (canceled)

16. The process according to claim 6 wherein the indirect heating is carried out with a fluid selected from the group consisting of oil and steam.

17. The process according to claim 6 wherein the indirect heating of the calcining device is brought with internal heating elements heated with a heating fluid, and wherein the heating elements surface and the heating fluid temperature are adjusted in order to reach a final temperature of the calcined trona between 130° C. and 180° C.

18. The process according to claim 17 wherein the indirect heating elements surface and the heating fluid temperature are adjusted in order to reach a final temperature of the calcined trona between 150° C. and 170° C.

19. The process according to claim 8 wherein the introduction device is formed by a rotating screw delivering the crushed trona at a screw outlet inside an heated section of the rotary drum, and wherein the introduction device has an outer surface equipped with a double shield heated with a hot fluid.

20. The process according to claim 1, wherein said trona ore contains more than about 90% sodium sesquicarbonate, and crushing the trona ore in step a) is carried out to obtain a crushed trona at a size below 0.7 cm;
wherein in step b), the crushed trona is introduced in the rotary drum equipped with indirect heating tubes fed with pressurized water steam between 20 and 33 bars;
wherein step c) further comprises setting the feeding rate of the calcining device so that the calcined trona withdrawn from the calcining device has a final temperature between 150° C. and 170° C., and setting a partial vacuum into the rotary drum so that oxygen concentration in the humid gas present in the rotary drum during calcining is less than 4 volume %; and
wherein said produced gas has a carbon dioxide concentration of more than 80 volume percents expressed on dry gas and a quantity of volatile organic compounds of less than 350 mg/kg expressed in mg of carbon per kilogram of generated carbon dioxide.

21. The process according to claim 1 wherein the produced gas has a quantity of volatile organic compounds of more than 33 and less than 350 mg per kilogram of generated carbon dioxide.

22. The process according to claim 1 wherein step c) comprises limiting air introduction in the calcining device so that to obtain a carbon dioxide concentration of more than 25 volume percents expressed on dry gas in the gas generated by the trona ore calcination.
